(19) United States
(12) Patent Application Publication
(10) Pub. No.: US 2016/0196785 A1
(43) Pub. Date: Jul. 7, 2016

(54) MULTIPLE DISPLAY DEVICE

(71) Applicant: HJ Forever Patents B.V., Rotterdam (NL)

(72) Inventor: Henricus Johannes Amesz, Rotterdam (NL)

(21) Appl. No.: 15/068,337

(22) Filed: Mar. 11, 2016

Related U.S. Application Data
(63) Continuation of application No. PCT/NL2014/050623, filed on Sep. 11, 2014.

(30) Foreign Application Priority Data
Sep. 12, 2013 (NL) 2011431

(51) Int. Cl. G09G 3/34; G02F 1/167; G06F 3/041; G06F 3/14; G06F 3/147

(52) U.S. Cl. CPC G09G 3/3486; G06F 3/1446; G06F 3/147; G09G 3/344; G06F 3/0412; G02F 1/167; G09G 2300/023; G09G 2300/0465; G02F 2001/1678; G02F 2001/1676

(57) ABSTRACT

An electronic device comprising a first flat element comprising a first and a second electronic display device, having pixels, and comprising various further elements, as well as use thereof. Preferably the device comprises an electrophoretic display device.

### CROSS-REFERENCE TO RELATED APPLICATIONS

This application is a continuation of International Application PCT/NL2014/050623 A1, entitled “MULTIPLE DISPLAY DEVICE”, to HJ Patents B.V., filed on Sep. 11, 2014, which claims priority to Netherlands Patent Application Serial No. 2011431, filed Sep. 12, 2013, and the specifications and claims thereof are incorporated herein by reference. The applications are legally transferred to HJ Forever Patents B.V.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention is in the field of an electronic device comprising a first flat element comprising a first and a second electronic display device, having pixels, and comprising various further elements, as well as uses thereof. In a preferred embodiment the present electronic device comprises an electrophoretic display device.

2. Description of Related Art

Electronic display devices and especially electrophoretic display devices are a relatively new technique of pixilated display devices in which charged pigment particles are moved to generate a required pigmentation of a pixel.

For further details of present developments in this field as well as for drawbacks of the present technology reference is made to recently filed NL2010936, which reference is incorporated herein by explicit reference. Some details are provided below.

A benefit of the in-plane switching of charged particles is that the electrophoretic display device may comprise a transparent state, allowing a choice of reflector or possibly backlight.

However, in an electrophoretic display it is relatively difficult to control the electrical field and particle motion distribution accurately enough to provide a homogenous pixel absorbance in the “dark” state.

Also switching from a first state to a second state in the above display may be relatively slow; typically too slow for many applications, even with recently improved devices. It is noted that typically prior art particles move at a speed of less than about 1 mm per second, which is considered at least ten times too slow for certain applications.

It is noted that some major companies developing displays have stopped to develop electrophoretic displays, being discouraged by negative results, complexity of the technology, and lack of prospect. For similar reason providers of pigmented particles had stopped further development as well.

Use and practical applications of the above electronic displays are so far limited, typically to relatively expensive devices.

Electronic devices, such as mobile telephones and (laptop) computers typically have an integrated screen. Mobile phones and (laptop) computers are typically equipped with various elements, such as a battery, an input device, such as a keypad and a touch screen, and a single screen. In phones typically a SIM card is present, or a similar card such as an R-UIM. Many equipment may have a unique identifier. In case of a computer further elements may be present, such as a pointing device, e.g., a mouse, and/or may be connected thereto.

The single screen has various limitations. For instance, the screen has a limited viewing angle; as a consequence typically only one person, at the most a few, can view the screen at the same time. For a relatively small screen the number of viewers is even smaller. The screen is further not optimized in terms of energy consumption; typically all of the screen operates in full color, or in black and white, thereby consuming more energy than strictly necessary. Further typically applications work under similar or the same boundary conditions, e.g., in full color. Resolution of screens is also limited, e.g., to 10-30 dots per inch (DPI), which is for many applications considered too low. It is noted that high end mobile phones may have a somewhat higher resolution, e.g. up to 100 DPI. In view of resolutions of, e.g., photos and optical cameras such is relatively low.

Various documents recite multiple display devices.

US2012/081272 (A1) recites a display apparatus including a display section that includes a plurality of thin display devices formed at multiple layers such that their display screens overlap with one another, wherein at least one of the display devices closest to a viewing side of the display section is configured to be transparent, and control means for controlling each display of the plurality of display devices of the display section.

U.S. Pat. No. 6,819,309 B1 recites a double-face display device which is formed of a substrate sheet having a first surface and a second surface, a first display medium disposed over the first surface, a second display medium disposed over the second surface, and a first display electrode and a second display electrode disposed in association with the first display medium and the second display medium, respectively. A first switching device and a second switching device are electrically connected to the first display electrode and the second display electrode, respectively, so that voltages are applied to the first and second display electrodes via the first and second switching devices, respectively, thereby driving the first and second display media to display data on both faces of the display device. The production of the double-face display device is rationalized by disposing the first and second switching devices on a common surface within the display device. The common surface may be given by one of the first and second surfaces of the substrate sheet or an inter-layer surface between layer sheets forming the substrate sheet in a laminated form.

US2011/164047 (A1) recites a method and system for displaying images on a transparent display of an electronic device. The display may include one or more display screens as well as a flexible circuit for connecting the display screens with internal circuitry of the electronic device. Furthermore, the display screens may allow for overlaying of images over real world viewable objects, as well as a visible window to be present on an otherwise opaque display screen. Additionally, the display may include active and passive display screens that may be utilized based on images to be displayed.

The above mentioned three patent documents do not provide a solution to all or most of the present problems, unfortunately.

It is an objective of the present invention to overcome disadvantages of the prior art electronic devices without jeopardizing functionality and advantages.

### BRIEF SUMMARY OF THE INVENTION

The present invention relates in a first aspect to an electronic device according to claim 1, and in a second aspect to use of thereof.

In view of the present electrophoretic display device it is noted that a pixel thereof comprises an enclosed space, having a liquid and pigment particles. The pigment particles are allowed to move freely throughout the space, typically in a horizontal direction. The space (or pixel) typically is in the order of 50-500 μm. Upon applying an electro-magnetic field the pigment particles move through the liquid, from a storage area to an aperture area, and vice versa. In the storage area the particles are hidden from a viewer. E-ink technology, such as of US2002/167500 A1, is a different technology. Pigment particles can not freely move, as they are enclosed in microcapsules. Also pigment particles are relatively large, typically larger than 500 nm (0.5 μm), and on average 1 μm or larger. Upon applying an electric field negatively charged black particles may move from a light state to a dark state, that is from a bottom to a top of the microcapsule, i.e. in a vertical direction. In the light state the black particles are not visible because white particles are in their view path, whereas in the dark state the black particles are in the view path of the black particles. The microcapsules are relatively small (50 μm or less). It is noted that despite claims colored particles are simply not available for the E-ink technology. Only by applying a color filter a color may be provided. At best such relates to a very limited number of colors, and certainly not to full color displays. E-ink, is however at present much more “bi-stable” (black-white) than the present electrophoretic displays (visible versus hidden); it is also is capable of much faster switching between the bi-stable states. E-ink has as (further) disadvantage that is relatively difficult to produce, production is expensive, and production yield is too low (too much fracture, too much waste).

The present invention relies partly on earlier research and development by IRX Technologies B.V. For that reason and for better understanding of the underlying technology reference is made to recently filed (Jun. 7, 2013) Dutch Patent application NL2010936. Various aspects, examples, advantages and so forth are in principle one to one applicable to the present invention. It is noted that the technology disclosed in the above patent applications has not been put into practice yet. Various obstacles have been encountered that still had to be solved. For instance bi-stability and switching times were not according to standards. Various other aspects, examples, advantages and so forth are in principle one to one applicable to the present invention. The teachings and examples of the above document are incorporated by reference herein. The present invention provides amongst others an improved layout in view of the prior art.

The present device comprises a first flat element comprising at least one screen. A second screen may be provided, as well as further screens, e.g., on a second side (back side) of the first flat element. The screens may in a way be considered as “windows”, each window being capable of providing images. Contrary to windows the present display devices are fixed on a specific location; as such a display device may cover substantially a full area of the first screen, or a part thereof. Electronic display devices may overlap one and another fully or partly. The display devices comprise pixels. The display devices may be of various nature, or may be of a similar or same nature, e.g. be all electrophoretic display devices. The display devices may be (partly) stacked on one and another, may be combined, e.g., integrated, and combinations thereof. The pixels of each device may fully or partly overlap, may be intercalated, areas on a screen may have just one type of pixels/display device, and combinations thereof. Clearly integration of pixels and display devices may have as a consequence that more than one driver circuit is present, and the more than one driver circuits need individual and combined control. Such may be considered as a complicating factor for the present design.

An important advantage of the present (electrophoretic) pixel and display device is that they may be visible in full sunlight.

The term “optical” may relate to wavelengths visible to a human eye (about 380 nm-about 750 nm), where applicable, and may relate to a broader range of wavelengths, including infrared (about 750 nm-1 mm) and ultraviolet (about 10 nm-380 nm), and sub-selections thereof, where applicable.

Even further the present pixel and device are fully adaptable, e.g., to changing light conditions.

The present electronic display device comprises pixels therein, which pixels can be changed instantly, i.e., within a few milliseconds, e.g., replacing an image by another.

It has recently been found that charged particles do not remain in the storage area for a sufficiently long time. For prior art devices particles remain in a storage area during less than a few seconds, during which the aperture area is almost fully covered with particles, therewith deleting any image. In view thereof a restrictor is provided. As a result both the switching time and bi-stable time are acceptable. The switching time is below 1 second, typically below 500 mseconds, such as below 350 mseconds, whereas the bi-stable time is above 10 seconds, typically above 120 seconds. The present restrictor also overcomes a prior art need to totally refresh an image; such an image would disappear for about 0.5 seconds; with the present restrictor only fading needs to be compensated for. The present restrictor is preferably a switchable restrictor, i.e., it may be in an active state or in a passive state. The restrictor especially improves the bi-stable time by at least a factor, such by at least two times, and typically by at least ten times. Thereby the restrictor makes it possible to use the present pixels in many envisaged applications, whereas without the restrictor effectively the pixels can not be put into practical use, albeit at the expense of some limited power consumption.

In an example of the present pixel the restrictor is one or more of an electro-magnetic field of opposite character of the pigment particle charge provided in the storage area, an electro-magnetic field of same character of the pigment particle charge provided in the aperture area, a chemical changer of the pigment particles, a temperature sensitive gel, and a magnetic changer of the pigment particles. The electro-magnetic field may be provided at regular intervals, such as once every second during a few milliseconds, preferably at a limited rate, such as once every 10 seconds, or once every minute. The electro-magnetic field may be a direct field or an alternating field. In view of particles an alternating field may be preferred. Such depends a bit on a type of pigments used, the fluid used, etc. An advantage is that an image remains, to the human eye, relatively stable, especially as no need for a complete refresh of an image is required. The field may be an electrical field, such as a field of 0.25-48 V, preferably 0.3-24 V. Likewise a magnetic field can be applied. The restrictor may also relate to a chemical change of particles and/or fluid. Such a change can be established by e.g. an acid-base reaction, a temperature change, and a change in electro-magnetic field, thereby changing a charge of the pigment. As such the pigment particle may be coated with a compound, the compound being capable of the mentioned acid-base reaction. As an example of a temperature sensitive gel polyisocyanopeptides, grafted with oligo (ethylene glycol) side chains are mentioned. These gels are found to increase the viscosity with increasing temperature in a drastic fashion. Such a gel is especially advantageous when using the present pixels at an elevated temperature, such as a window blind. Also a change in magnetic properties may be used, such as caused by hysteresis, wherein the hysteresis is preferably (semi-) symmetrical with respect to a field applied.

The present device comprises a driver circuit for changing appearance of (individual) pixels by applying an electro-magnetic field. As such also appearance of the display device, or one or more parts thereof, may be changed.

The present device may further comprise a means for receiving data, such as individual pixel data, pixel color data, pixel filter data, pixel spectral data, pixel reflectivity data, pixel transmittance data, pixel intensity data, and display pattern data, etc. As such the present device can be controlled on a pixel level, on a display level, on a matrix of pixels level, and combinations thereof. It is preferred to provide data in a wireless mode; however data may also be provided by connecting a cable or the like, such as be providing a USB-port or the like. For the wireless mode preferably an RFID per display device is provided, as well as a transmitter for communicating with the display, preferably a transceiver, for also receiving data from a display. As such each individual display device and display can be adapted, e.g., according to wishes of a user, and to light conditions.

The present electronic device may comprise a unique code for identification. As such every electronic device can be identified individually.

In principle the present electronic device may comprise any number of individual display devices, such as two, three, or even ten. The number of display devices may typically be adapted to specific requirements. For instance, a first screen on the first flat element may comprise two individual display devices on a first side thereof, the first flat element comprising one or two further display devices on a second side thereof, on a second flat element of the electronic device further two individual display devices may be provided, such as a touch screen functioning as a keyboard, and a second touch screen functioning as a mouse pad. Thus the number of display devices can be adapted to specific conditions and requirements. An electronic device may cover a certain area of a first (or second) flat element, or a total area thereof. A first flat element may thus comprise a first display device on a first side thereof, and a second display device on a second side thereof. In an example, if one or more display devices are each individually provided on a first and a second side (of a first flat element), images provided on the first side are rotated 180° (e.g., along a virtual vertical axis) to provide (readable) images on a second side thereof. An electronic device may also comprise more than one display devices on one side thereof. Also combinations of the foregoing are possible.

The present display device is relatively thin and can therefore in principle be applied to any electronic device per se, or in a stack of devices. The display present has a thickness <0.1 cm, preferably a thickness of 2 μm-500 μm, more preferably a thickness of 3 μm-300 μm, even more preferably a thickness of 5 μm-200 μm, such as 10 μm-100 μm. A thickness may vary, e.g. depending on a number of devices applied. As such the present display device (in a transparent mode) is not or hardly visible for a human eye.

The present device comprises one or more input devices, such as a keyboard, a mouse, a touch screen, etc. Also optical and audio input means may be present.

The present device comprises a processing unit, typically a CPU, for processing input, providing output, processing data, etc. Also a power supply is provided, typically a battery.

Thereby the present invention provides a solution to one or more of the above mentioned problems.

Advantages of the present description are detailed throughout the description.

### DETAILED DESCRIPTION OF THE INVENTION

The present invention relates in a first aspect to an electronic device according to claim 1.

In an example the present device comprises a means for processing data, such as a CPU, for making received data visible, for addressing individual pixels, for refreshing a display, etc. The device may further comprise a means for near field communication, such as a receiver and a transmitter. As such a display device may directly be addressed using a suitable signal, the signal providing updated information. Typically such communication also involves handshaking protocols, such as identifying an ID of a device and, e.g., a computer or the like providing further information.

It is noted that by providing (wireless) signals like all display devices may be updated within a small time frame, if required. Such can be repeated, e.g., every hour, or every minute, or every second. In fact continuous communication between device and information providing means, such as a computer, may be continuous. As such performance of the present electronic device may be adapted (almost) continuously.

As the present device and in particular an electrophoretic display device consumes a minute amount of energy a small means of providing power, such as a battery, a capacitor, a coil, etc may be provided. It is noted that power consumption of the present device is so low that the display needs to be refreshed at the most only every two hours.

The present device may in an example comprise a controller, such as a chip, a CPU. The controller, driver, power supply, means for transmitting and receiving may be integrated.

In an example of the present electronic device the first and second display devices are visible at a first side of the first flat element, wherein the second electronic display device overlaps the first electronic display device at least partially. In an example more than one display devices may be provided, wherein the displays may be stacked, may be placed on various locations on the present screen, such as one inside and one outside, etc. If a present device is placed on an outside of flat element, a protective layer or coating may be provided. Typically the present devices may already have an outer layer, the outer layer also functioning to protect the device.

In an example of the present electronic device the first flat element comprises a second screen at a second side thereof, wherein the second display device is visible at the second side of the first flat element, wherein the second electronic display device overlaps the first electronic display device at least partially.

In an example a means for providing power is provided, such as a battery. Likewise the present device may be connected to a power grid.

In an example the present electronic device may comprise three display devices, two display devices at a first side of the first fiat element, and one display device at a second side of the first flat element.

In an example the present electronic device may comprise further display devices, such as a touchscreen device acting as a keyboard, a touchscreen device acting as a pointing device, and/or wherein one or more of the three display devices comprise a touch screen.

In an example the present device each display device is individually selected from an electrophoretic display, an LCD, a LED-display, and a combination thereof. In view of, e.g., energy consumption, resolution, and visibility, an electrophoretic display is preferred. However, if also actively light needs to be provided a LED-display may be included as well.

In an example of the present device the display device has a thickness <0.1 cm, preferably a thickness of 2 μm-500 μm, more preferably a thickness of 3 μm-300 μm, even more preferably a thickness of 5 μm-200 μm, such as 10 μm-100 μm.

In an example the present electrophoretic display device comprises sophisticated pixels, the pixels comprising at least one aperture area being visible. The present pixel can be switched relatively quick, in the order of (a few) milliseconds, which is considered fast enough for most applications. The present pixel comprises an aperture, for allowing passage of light, in principle into and out of the pixel. It is noted that a pixel is confined by, e.g., an upper transparent glass plate, protecting the pixel from the environment. The upper part is visible to a user. Part of the upper part relates to an aperture area. The aperture area may comprise further optical elements, such as a lens, e.g., a Fresnel lens, a prism, etc. Another part comprises further functional elements of the pixel, typically (intentionally) not transparent to light.

The pixel comprises a fluid (or liquid). The fluid may be any suitable fluid and a combination of suitable fluids. It is preferred to use a relatively low viscosity fluid, such as having a dynamic viscosity of 1 mPa·s or less. The fluid comprises at least one type of pigment particles having a diameter smaller than 500 nm. The diameter is defined herein to be the largest distance that can be formed between two opposite parallel lines tangent to its boundary. It has been found that these particles provide a good distribution of particles over the present (field) electrode. In view of an electro-magnetic field to be applied the present particles are being chargeable or charged. Likewise magnetic particles may be used. A small charge per particle is found to be sufficient, such as from 0.1 e to 10 e per particle. A concentration of particles is in the order of 1-100 q/l. A size of an electric potential is in the order of 0.5-50 V, preferably from 1-20 V, such as 5-15 V. For the present pixel a relatively large potential is preferred, e.g. 15-10 V. It has been found that fluid behaviour is better at a higher voltage, e.g., in terms of flow, and switching time. It is preferred to have particles charge stabilized. As such a better performance e.g., in view of distribution over the field electrode, and faster and better controllable switching times are achieved.

The pixel further comprises at least two electrodes spaced apart for providing an electric-magnetic field, of which at least one electrode is an accumulation electrode and at least one electrode is a field electrode. The accumulation electrode accumulates particles when these are intended not to be visible, whereas the field electrode attracts particles when these are intended to be visible. As a consequence the at least one field electrode occupies a field electrode area, the field electrode area and aperture area largely coinciding. One electrode may relate to an electrically neutral (or ground) electrode. It is noted that the terms “accumulation” and “field” relate to a function intended by the respective electrodes.

In an example a thin-film transistor is applied to drive a pixel, optionally in combination with other drivers.

Further the pixel comprises at least one storage area for storing the at least one type of pigment particles out of sight. As a consequence the at least one storage area is adjacent to the at least one aperture area.

For improved performance, e.g., in terms of switching time, distribution of particles, durability, etc. it is preferred to have at least two accumulation electrodes and at least two field electrodes, more preferably at least one of each electrode located at a side of the pixel.

As mentioned above the present pixel may be relatively small. When switching time and/or optical resolution become more critical smaller pixels are preferred having a length of the pixel smaller than 250 μm, preferably smaller than 150 μm, more preferably smaller than 100 μm, such as smaller than 90 μm. Present designs relate to a length of 150 μm, of 85 μm, of 75 μm, and of 50 μm. A smallest size considered at this point in time is about 25 μm. Also combinations of sizes are envisaged; such could imply a standardized unit length of e.g. 75 μm is used, and multiplicities thereof. From a production point of view somewhat larger pixels are preferred, such as having a length of 300 μm-500 μm. From a control point of view smaller pixels are preferred. Typically a width of the pixel has a similar or the same dimension. The present pixel now provides an optical resolution that is more than sufficient for any application considered at this point in time. In an example maps may be provided on a smartphone, having sufficient optical detail to find ones way. Further a reader can continue reading for a long period of time, without getting tired. It is noted that in this respect LCD-displays provide too much light.

In an example of the present pixel the fluid carries a charge. Such has been found to be particularly advantageous, in similar terms as mentioned above.

It has been found that a disadvantage of the present pixels, and especially of smaller pixels, is that an electrical breakdown may occur. In order to prevent such a breakdown further measures may be incorporated. In an example the fluid has a reduced permittivity εᵣ of less than 10, preferably of less than 5. However, such change in permittivity typically involves further compounds, such as oils, which are not (fully) compatible with other constituents. Thereto further compounds/components may be added, such as a surfactant, an emulsifier, a polar compound, and a compound capable of forming a hydrogen bond. In view of relatively quick switching times it has been found that the viscosity of the fluid is preferably less than 0.1 Pa*s, such as by using a mixture comprising ethylene glycol.

In an example the present pixel has a rectangular shape, such as a square shape, or a hexagonal shape. In view of switching times these layouts have been found to perform optimally. The hexagonal shape has a further advantage in that each side of the hexagon may be used for accumulating pigment particles. By varying charges or otherwise a first side can be used for red particles, a second side for green particles, and a third side for blue particles, and so further. Such could also be achieved by sub-dividing at least one side of a square pixel.

In an example of the present pixel the at least one type of pigment particles comprises one or more of white particles, red particles, green particles, blue particles, black particles, reflective particles, light absorbing particles, fluorescent particles, and phosphorescing particles. As such a combination of visible pigment particles may be provided, thereby obtaining any intended colour, in any intended brightness. In principle the same effect could be obtained by using one or more pigment particles that absorb (a specific wave-length (region) of) light. Likewise also reflective pigments may be used. The present small pixel size makes it possible to make, e.g., in a matrix format a red pixel, adjacent to a blue pixel, adjacent to a green pixel, etc. As such a mixture of colours may be provided by activating an intended pixel, in an intended intensity, etc.

In an example of the present pixel each type of pigment particle carries a significantly different charge, such as one being charged positively, another negatively, a third with a small charge, and a fourth with a large charge, etc. In an example the charge is from 5*10⁻⁷-0.1 C/m², such as from 1*10⁻⁵-0.01 C/m². In an example the present pigment may change colour or appearance upon applying an electro-magnetic field, or likewise upon removing such a field.

In an example of the present pixel the pigment particles are smaller than 400 nm, preferably smaller than 100 nm, typically larger than 10 nm. In view of performance, switching times, distribution, etc. the above sizes are found to be optimal. It is preferred to provide a stable dispersion; as such the above sizes are preferred. The particle size is considered to be a measure of an averaged diameter thereof.

In an example the present fluid is provided in an amount of 1-100 gr/m², preferably 2-75 gr/m², more preferably 20-50 gr/m², such as 30-40 gr/m², and the present pigments are provided in an amount of 0.02-30 gr/m², preferably 0.05-10 gr/m², more preferably 0.5-5 gr/m², such as 1-3 gr/m².

In an example the present pixel further comprises a UV-filter. Such is not considered yet, however, inventors have identified that some of the elements inside a pixel and possibly a transparent layer are preferably protected from environmental effects, such as UV-light. In an example especially an electrode needs to be protected from UV-light.

In an example of the present pixel the aperture area is more than 90% transparent, preferably more than 95%. The aperture area may be made of glass and a suitable polymer, such as poly carbonate (Perspex). The material for the aperture, e.g., glass, may have a thickness of 0.2 μm-2 mm. If a flexible pixel and/or display are required it is preferred to use a thin material. If some strength is required, a thicker material is preferred. It has been found that with such transparency energy consumption can even be further reduced. In this respect it is noted that the present pixel uses about 0.1% of prior art pixels, such as LCD-pixels. Such provides huge advantages, e.g., in terms of usage, reduced need for loading devices, smaller charge storing devices, etc. Especially when a power grid is not available such will be appreciated. It is noted that power consumption of e.g., smartphones is significant. Any reduction in power consumption will be beneficial to the earth.

In an example of the present pixel the at least one field electrode is at least partly transparent to visible light, preferably more than 95% transparent. In an example an upper electrode, e.g., in a stack of pixels, is preferably as transparent as possible. In a further example the at least one field electrode is at least partly reflective to visible light, preferably more than 95% reflective, such as when forming a “bottom” electrode, such as in a lowest pixel in a stack. Also combination of the above is envisaged.

In an example the present electronic device comprises a photo-voltaic layer. The layer may be present as a separate layer, such as an overlay in the present display device, a layer on a side of the present electronic device, or may be fully integrated, e.g., within the present pixel. If a photo-voltaic layer is present a need for a power supply of the present device may be absent altogether.

In an example the present pixel comprises one or more vortices in a plane of the pixel, wherein the one or more vortices have a dimension in the order of 0.8-1.2 times a pixel. diameter, preferably 0.9-1.1 times a diameter. Such allows an improved liquid flow onto and from a pixel electrode.

In an example the present pixel comprises a pumping area, the pumping area preferably having a width of 0.1-0.3 times a width of a pixel, and a length of 0.1-0.4 times a width of a storage area. Such provides both a small electrode distance with a high field, and exerts a high force upon the particles and fluid, and therefore induces a strong electro-osmotic flow onto the pixel electrode, and into a wider escape area next to it, which allows the liquid to leave the pixel again in a different direction.

In an example a stack of present pixels is envisaged comprising at least two pixels according to the invention. In an example three pixels may be stacked, such as a red pigment comprising pixel, a green pigment comprising pixel, and a blue pigment comprising pixel. In an example a fully reflective pixel may be present in a first layer, coloured pigments in a second layer, and black and white pixels in a third layer. As such any combination of layers, and pigments therein, may be possible.

In an example the present electrophoretic display device further comprises a driver circuit for driving the one or more pixels by providing an electro-magnetic field, typically an electrical field. The applied voltage is in an example 15-30 V, preferably being large enough to move particles. Preferably counter ions are present.

In an example the electrophoretic display device comprises at least one shared field electrode. The shared field electrode may be shared by at least two pixels, typically by a row or column of pixels.

The present driver circuit for use in an electrophoretic display device according to the invention or in a pixel according to the invention, may comprise a means for providing a time varying electro-magnetic field between the at least one field electrode and the at least one accumulation electrode. Therewith movement from charged pigment particles to and from an accumulation electrode and from and to a field electrode is effected. The driver circuit may further provide an electro-magnetic field for clearing pixels (removing charged particles), for driving pixels (introducing charged particles), for resetting pixels (moving charged particles to an initial position). And for applying a static charge, for remaining charged pixels in position occupied at a point in time. Also a field for refreshing may be provided, e.g., for having a similar or same amount of pixels in an earlier position.

In an example the driver circuit comprises a switch for providing a static electro-magnetic field or charge to one or more of the electrodes. In an example only very scarcely a static pulse, or likewise a refresh pulse is provided, such as once every two hours. The pulse may be short and at a low intensity.

In an example the electronic display comprising pixels is provided in a flexible polymer, and the remainder of the display device is provided in glass. The glass may be rigid glass or flexible glass. If required a protection layer is provided. If more than one colour is provided, more than one layer of flexible polymer may be provided. The polymer may be poly ethylene naphthalate (PEN), poly ethylene terephthalate (PET) (optionally having a SiN layer), poly ethylene (PE), etc.

In a further example the electronic display comprising pixels is provided in at least one flexible polymer. As such the display may be attached to any surface, such as by using an adhesive.

In a second aspect the present invention relates to a use of an electronic device according to the invention, preferably an electrophoretic display device, for one or more of presenting data, and projecting data.

The present resolution may be in the order of 300 DPI, or better. A size of a display device may be relatively small such as from 10 cm² (or smaller), up to relatively large scale, e.g. 2000 cm².

It is noted that the present invention can be combined with, e.g., an LCD-screen, keeping information much longer available for a reader and at a much lower energy consumption.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

The invention although described in detailed explanatory context may be best understood in conjunction with the accompanying examples and figures.

### SUMMARY OF FIGURES

FIGS. 1a-f show worked open and side views of a layout of an electronic device according to the invention.

### DETAILED DESCRIPTION OF FIGURES

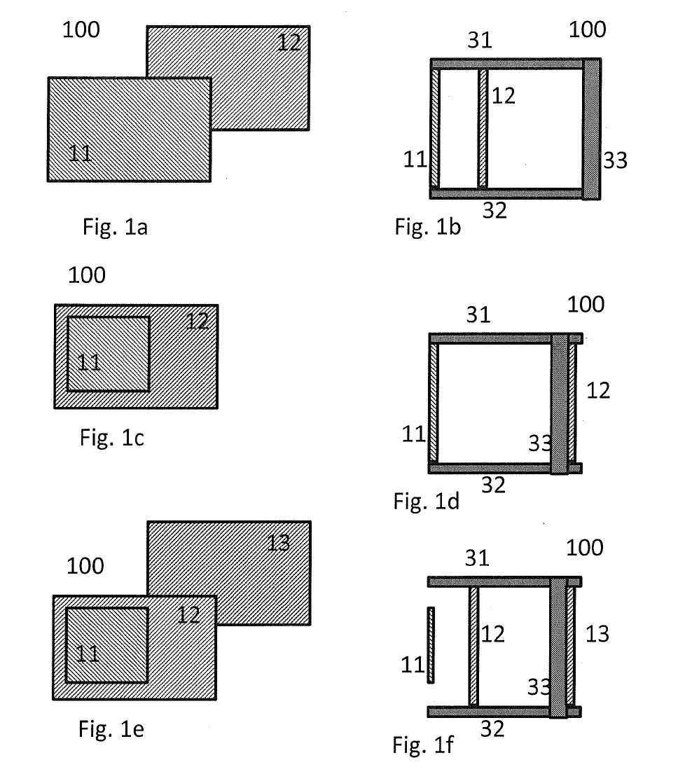

FIG. 1a shows a worked open view of an example of a layout of an electronic device 100. Therein a sequence of display devices 11,12 is provided. A first display device 11, and overlapping therewith a display device 12, e.g., according to the invention.

FIG. 1b provides a side view of an example of the present electronic device 100. Therein further a top and bottom element 31 and 32, respectively, are provided, such as a frame, for enclosing open spaces in between display devices and fixing elements into place. Further a back cover 33 is provided.

FIG. 1c shows a worked open view of an example of a layout of an electronic device 100. Therein a sequence of display devices 11,12 is provided. A first display device 11, and party overlapping therewith a display device 12, e.g., according to the invention.

FIG. 1d provides a side view of an example of the present electronic device 100 having a first display device 11 at a “front’ side thereof. Therein further a top and bottom element 31 and 32, respectively, are provided, such as a frame, for enclosing open spaces in between display devices and fixing elements into place. Further a back cover 33 is provided. On a “back” side a second display device 12 is provided.

FIG. 1e shows a worked open view of an example of a layout of an electronic device 100. Therein a sequence of display devices 11,12 is provided on a “front” side thereof. A first display device 11, and party overlapping therewith a display device 12, e.g., according to the invention. On a “back” side a third display device 13 is provided.

FIG. 1f provides a side view of an example of the present electronic device 100 having a sequence of display devices 11,12 on a “front” side thereof. Therein further a top and bottom element 31 and 32, respectively, are provided, such as a frame, for enclosing open spaces in between display devices and fixing elements into place. Further a back cover 33 is provided. On a “back” side a third display device 13 is provided.

It should be appreciated that for commercial application it may be preferable to use one or more variations of the present system, which would similar be to the ones disclosed in the present application and are within the spirit of the invention.

What is claimed is:

1. An electronic device comprising
a first flat element, the first flat element comprising a first screen, the first flat element comprising a first electronic display device and a second electronic display device, wherein each display device is individually selected from an electrophoretic display, an LCD, a LED-display, and a combination thereof, and wherein the device comprises at least one electrophoretic display, the at least one electrophoretic display comprising a restrictor for maintaining pigment particles in a storage area thereof,
wherein the first and second electronic display devices comprise each individually or combined pixels,
a driver circuit for applying an electro-magnetic field to the pixels,
an input device for entering data,
a processing unit, and
a power supply.

2. The electronic device according to claim 1, wherein the first and second display devices are visible at a first side of the first flat element, wherein the second electronic display device overlaps the first electronic display device at least partially.

3. The electronic device according to claim 1, wherein the first flat element comprises a second screen at a second side thereof, wherein the second display device is visible at the second side of the first flat element, wherein the second electronic display device overlaps the first electronic display device at least partially.

4. The electronic device according to claim 1, comprising three display devices, two display devices at a first side of the first fiat element, and one display device at a second side of the first flat element.

5. The electronic device according to claim 1, comprising further display devices, and wherein one or more of the three display devices comprise a touch screen.

6. The electronic device according to claim 5, comprising at least one of a touchscreen device acting as a keyboard, and a touchscreen device acting as a pointing device.

7. The electronic device according to claim 1, wherein the display device has a thickness <0.1 cm, and wherein the first and second electronic display devices comprise each individually at least one of
a pointing device,
a unique code for identification,
a means for receiving data, and
a means for transmitting data.

8. The electronic device according to claim 1, wherein the electrophoretic display comprises electrophoretic pixels, the electrophoretic pixel comprising
at least one aperture area being visible,
a fluid comprising at least one type of pigment particles having a diameter smaller than 500 nm, the particles being chargeable or charged,
at least two electrodes spaced apart for providing an electric-magnetic field, of which at least one electrode is an accumulation electrode and at least one electrode is a field. electrode, wherein the at least one field electrode occupies an field electrode area, the field electrode area and aperture area large coinciding, and
at least one storage area for storing the at least one type of pigment particles preferably out of sight, wherein the at least one storage area is adjacent to the at least one aperture area, and
wherein a length of the pixel is smaller than 300 μm.

9. The electronic device according to claim 8, wherein one or more of
the fluid carries a charge,
the fluid comprises one or more of a surfactant, an emulsifier, a polar compound, and a compound capable of forming a hydrogen bond,
the fluid has a relative permittivity εᵣ of less than 10, and a viscosity of less than 0.1 Pa*s,
the fluid is provided in an amount of 1-100 gr/m²,
the pigments are provided in an amount of 0.02-30 gr/m²,
the pixel has a rectangular shape,
the at least one type of pigment particles comprise one or more of white particles, red particles, green particles, blue particles, black particles, reflective particles, light absorbing particles, fluorescent particles, and phosphorescing particles,
each type of pigment particle carries a significantly different charge, the charge being from 5*10⁻⁷-0.1 C/m², and
the pigment particles are smaller than 400 nm.

10. The electronic device according to claim 8, wherein the at least one field electrode is at least partly transparent to visible light, or wherein the at least one field electrode is at least partly reflective to visible light.

11. The electronic device according to claim 8, wherein the aperture area is more than 90% transparent.

12. The electronic device according to claim 8, wherein the pixel comprises one or more vortices in a plane of the pixel, wherein the one or more vortices have a dimension in the order of 0.8-1.2 times a pixel diameter.

13. The electronic device according to claim 8, wherein the pixel comprises a pumping area.

14. The electronic device according to claim 8 comprising a driver circuit, the driver circuit comprising a means for providing a time varying electro-magnetic field between the at least one field electrode and the at least one accumulation electrode.

15. The electronic device according to claim 14, wherein the driver circuit comprises a switch for providing a static electro-magnetic field or charge to one or more of the electrodes.

16. Use of an electronic device according to claim 1 for one or both of presenting data and projecting data.
